(19) United States
(12) Patent Application Publication
(10) Pub. No.: US 2009/0321388 A1
(43) Pub. Date: Dec. 31, 2009

(54) Imprint stamper, manufacturing method of imprint stamper, magnetic recording medium, manufacturing method of magnetic recording medium and magnetic disk apparatus

(75) Inventors: Takeshi Okino, Kanagawa-ken (JP); Shinobu Sugimura, Kanagawa-ken (JP); Kazuto Kashiwagi, Tokyo (JP); Yoshiyuki Kamata, Tokyo (JP)

Correspondence Address: NIXON & VANDERHYE, PC, 901 NORTH GLEBE ROAD, 11TH FLOOR, ARLINGTON, VA, 22203, US

(73) Assignee: KABUSHIKI KAISHA TOSHIBA, Tokyo (JP)

(21) Appl. No.: 12/458,107

(22) Filed: Jun. 30, 2009

(30) Foreign Application Priority Data
Jun. 30, 2008 (JP) 2008-171324

(51) Int. Cl. C25D 1/10; B29C 43/02; C23F 1/00

(52) U.S. Cl. 216/22; 425/470; 205/70

(57) ABSTRACT

An imprint stamper for manufacturing a magnetic recording medium with a plurality of recording bits includes a plurality of first concave portions to form the recording bits, a wall portion provided so as to separate the first concave portions from each other, and a second concave portion provided to the wall portion so as to connect one of the first concave portions and the other of the first concave portions adjacent to one of the first concave portions.

### CROSS REFERENCE TO RELATED APPLICATION

This application is based upon and claims the benefit of priority from the prior Japanese Patent Application No. 2008-171324, filed on Jun. 30, 2008, the entire contents of which are incorporated herein by reference.

### FIELD OF THE INVENTION

The present invention relates to an imprint stamper, a manufacturing method of the stamper, a magnetic recording medium, a manufacturing method of the magnetic recording medium and a magnetic disk apparatus.

### DESCRIPTION OF THE BACKGROUND

In a high-density technical trend of magnetic recording media, what is called a “discrete track (DTR) medium” or a “bit patterned medium (BPM)” is attracting attention. DTR media are configured to separate adjacent recording tracks from one another by providing guard bands formed of grooves or a nonmagnetic material, the guard band reducing magnetic interference between the adjacent tracks. BPM is configured to have recording bits isolated from each other on a recording track, thus reducing magnetic interference between the bits.

Japanese patent JP-3850718 discloses a technology for imprinting a pattern of a discrete track type magnetic disk by an imprint method. The Japanese patent also describes that patterns on the disk are formed using a stamper produced from an original disk made using electron-beam lithography. The stamper can be obtained as follows. A substrate of the original disk is coated with a photosensitive resin (referred to as a “resist”, hereinafter). The substrate coated is exposed to an electron beam (referred to as an “EB”, hereinafter) and developed. The developed disk is further treated to give conductivity on the surface thereof. Then, electroforming is carried out onto the disk surface, producing the stamper. And a medium pattern is transferred onto a resist film on the disk substrate by using the stamper. The imprinted substrate then undergoes etching, etc. to be a magnetic recording medium with the pattern thereon. A reverse pattern from the pattern of the stamper is required to be precisely transferred to the substrate to be processed while imprinting.

The Japanese patent document describes that the medium pattern is formed using stampers started from the original disk produced by using an EB-lithography technology. However, drawing techniques with EB lithography or patterns of stampers are not addressed specifically.

### SUMMARY OF THE INVENTION

According to a first aspect of the invention, an imprint stamper for manufacturing a magnetic recording medium with a plurality of recording bits, includes a plurality of first concave portions to form the recording bits, a wall portion provided so as to separate the first concave portions from each other, and a second concave portion provided to the wall portion so as to connect one of the first concave portion and the other of the first concave portions adjacent to one of the first concave portion.

According to a second aspect of the invention, a method for manufacturing a stamper is provided. The method includes the steps of forming a positive type photosensitive resin film on a substrate, exposing an area of the positive type photosensitive resin film, so that a wall portion of the stamper is formed on the area, developing the positive type photosensitive resin film to remove the area, forming a conductive film on the positive type photosensitive resin film and the substrate after the developing, forming an electroformed film on the conductive film, and removing the conductive film and the electroformed film from the photosensitive resin film and the substrate.

According to a third aspect of the invention, a method for manufacturing a magnetic recording medium is provided. The method includes the steps of forming a resin layer on a substrate, imprinting on the resin layer by using the stamper to provide a third concave portion on the resin layer, etching the resin layer with the third concave portion and the substrate to provide a fourth concave portion on the substrate, and forming a magnetic film on the substrate with the fourth concave portion to provide a plurality of convex recording bits. The third concave portion is arranged so as to correspond to a pattern of the wall portions of the stamper. The fourth concave portion is arranged so as to correspond to a pattern of the wall portions of the stamper. The recording bits are arranged so as to correspond to a pattern of the first concave portions of the stamper.

### BRIEF DESCRIPTION OF DRAWINGS

The accompanying drawings, which are incorporated in and constitute a part of this specification, illustrate embodiments of the invention and together with the description, serve to explain the principles of the invention.

FIG. 1 is a perspective view showing a recording-bit portion of an imprint stamper according to a first embodiment of the invention.

FIG. 2 is a plan view showing the recording-bit portion of the imprint stamper according to the first embodiment of the invention.

FIG. 3 is a perspective view roughly illustrating a substantial portion of a magnetic disk apparatus according to the first embodiment of the present invention.

FIG. 4 is a plan view showing an example of a magnetic recording medium according to the first embodiment of the invention.

FIG. 5 is a plan view showing a modified example of the imprint stamper according to the first embodiment of the invention.

FIG. 6 is a plan view showing a modified example of the imprint stamper according to the first embodiment of the invention.

FIG. 7 is a plan view showing a modified example of the imprint stamper according to the first embodiment of the invention.

FIG. 8 is a plan view showing a modified example of the imprint stamper according to the first embodiment of the invention.

FIG. 9 is a plan view showing a modified example of the imprint stamper according to the first embodiment of the invention.

FIG. 10 is a plan view showing a modified example of the imprint stamper according to the first embodiment of the invention.

FIG. 11 is a plan view showing a modified example of the imprint stamper according to the first embodiment of the invention.

FIG. 12 is a plan view showing a modified example of the imprint stamper according to the first embodiment of the invention.

FIG. 13 is a plan view showing a modified example of the imprint stamper according to the first embodiment of the invention.

FIG. 14 is a plan view showing a modified example of the imprint stamper according to the first embodiment of the invention.

FIGS. 15A to 15F are sectional views showing a first manufacturing process of the imprint stamper according to the first embodiment of the invention.

FIG. 16 is a plan view showing an exposure pattern of an exposure process of the first manufacturing process of the imprint stamper according to the first embodiment of the invention.

FIGS. 17A to 17F are sectional views showing a second manufacturing process of the imprint stamper according to the first embodiment of the invention.

FIG. 18 is a plan view showing an exposure pattern of an exposure process of a second manufacturing process of the imprint stamper according to the first embodiment of the invention.

FIGS. 19A to 19F are sectional views showing a manufacturing process of the magnetic recording medium according to the first embodiment of the invention.

FIG. 20 is a perspective view showing an imprint stamper according to a comparative example of the imprint stamper according to the first embodiment of the invention.

FIG. 21 is a plan view showing an exposure pattern of an exposure process of the manufacturing process of the imprint stamper according to the comparative example of the imprint stamper according to the first embodiment of the invention.

FIGS. 22A to 22D are sectional views showing a manufacturing process of the magnetic recording medium according to a modified example of the first embodiment of the invention.

### DETAILED DESCRIPTION OF THE EMBODIMENTS ACCORDING TO THE PRESENT INVENTION

### First Embodiment

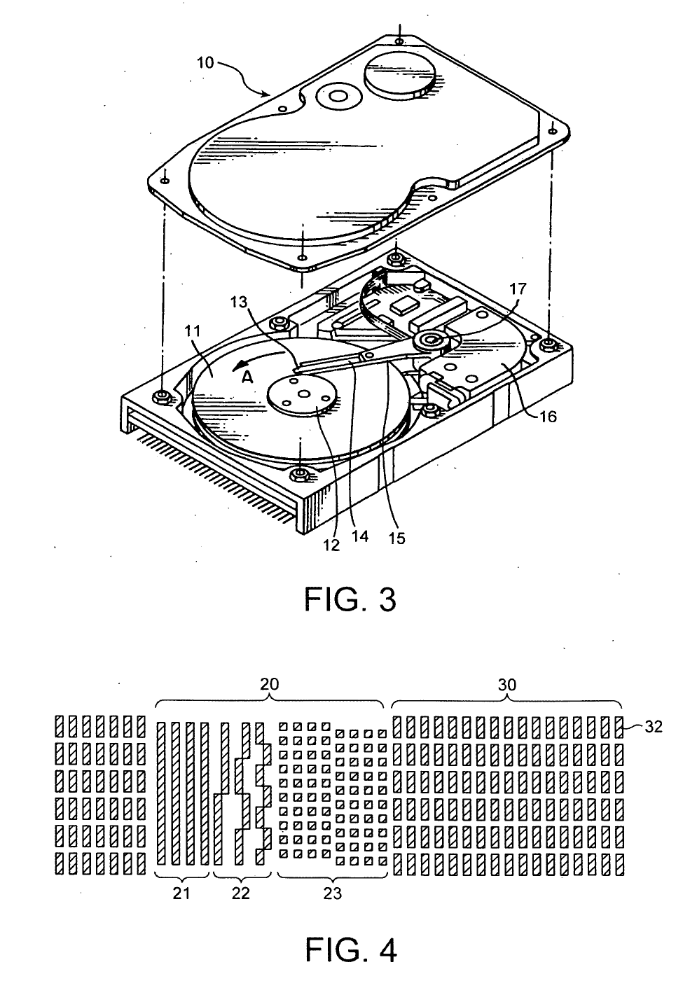

FIG. 3 is a perspective view illustrating a substantial portion of a magnetic disk apparatus according to a first embodiment of the present invention. The magnetic disk apparatus 10 according to the first embodiment of the invention is a system using a rotary actuator. In the figure, a spindle 12 is equipped with a magnetic recording medium 11, rotating in a direction of the arrow A by a motor (not shown) which responds to a control signal from a drive control portion (not shown). A head slider 13 is attached to a tip of a filmy suspension 14 in order to record/reproduce information stored in the magnetic recording medium 11. Here, the head slider 13 mounts a magnetic head near the tip thereof. When the magnetic medium 11 is rotated, the surface of the head slider 13 that faces the medium is held to have a certain flying height from the surface of the magnetic medium 11.

The suspension 14 is connected to an end of an actuator arm 15 with a bobbin portion suspending a driving coil (not shown). A voice coil motor 16, a type of a linear motor, is provided at the other end of the actuator arm 15. The voice coil motor 16 is composed of the driving coil (not shown) winded up around the bobbin portion and a magnetic circuit made of a permanent magnet and a counter-yoke arranged so as to sandwich the coil.

The actuator arm 15 is supported by ball bearings (not shown) provided at upper and lower portions of a pivot 17, and thus the arm 15 is set freely rotatable with the voice coil motor 16.

FIG. 4 is a plan view showing a portion of a magnetic recording medium according to the first embodiment of the invention. Here, the partial plan view of the magnetic recording medium shown in FIG. 4 is a plan view showing a portion of the upper surface of the magnetic recording medium 11 of the magnetic disk apparatus 10 shown in FIG. 3. The magnetic recording medium is sectioned to concentric tracks, each track having sectors partitioned with respect to each constant angle. On the magnetic recording medium, a data region 30 and a servo region 20 are provided alternately in a circumference direction. Each data region 30 includes recording bits 32. Each servo area 20 includes areas such as a preamble area 21, an address area 22, a burst area 23, etc. Moreover, a gap portion may be included in addition to these areas.

The present invention relates to an imprint stamper used to produce magnetic recording media.

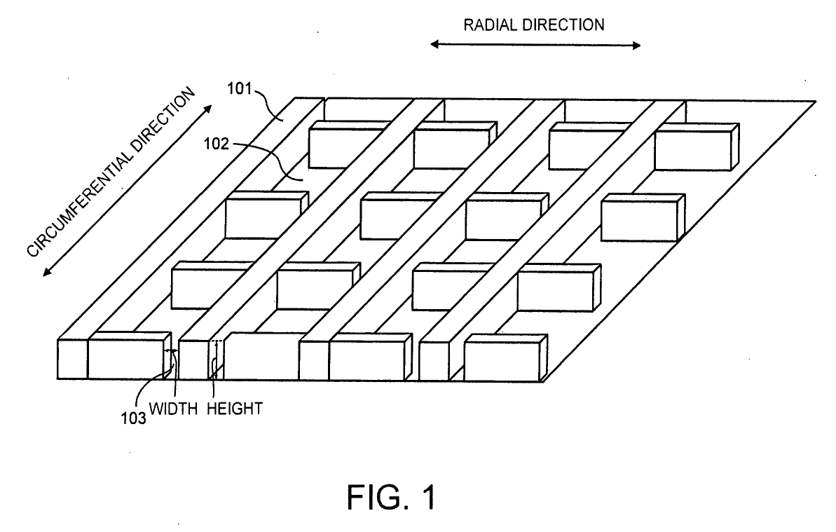

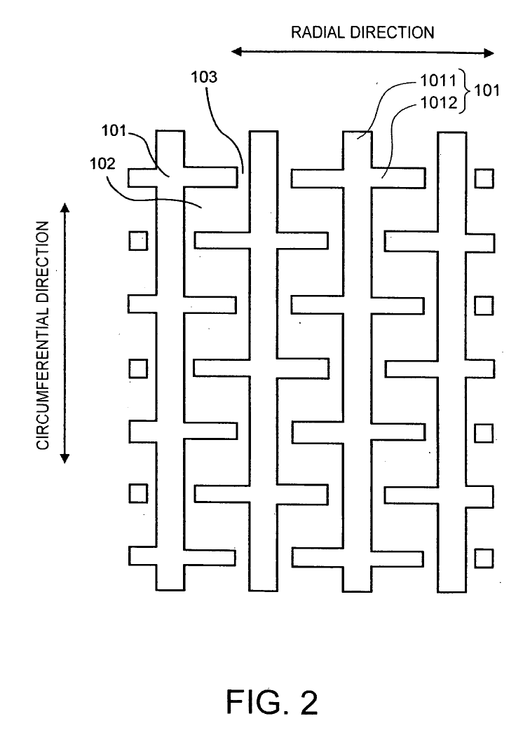

FIG. 1 is a perspective view showing a recording-bit portion of an imprint stamper according to the first embodiment of the invention. FIG. 2 is a plan view showing the recording-bit portion of the imprint stamper according to the first embodiment of the invention. As shown in FIGS. 1 and 2, the stamper according to the embodiment is an imprint stamper including a plurality of recording bits 32, concave portions or a nonmagnetic material provided for separating the bits from each other to form magnetic recording media. The stamper further includes first-concave portions 102 to define recording bits 32, wall portions 101 and second-concave portions 103. A wall portion 101 is composed of a circumferential wall portion 1011 like a tree trunk and a plurality of radial wall portions 1012 like tree branches growing from the trunk. All the wall portions 101 align parallel entirely so that one circumferential wall portion 1011 and the adjacent radial wall portions 1012 are not in touch with each other, forming constant spacing. The spacing corresponds to the second-concave portions 103. In other words, the wall portions 101 are provided with the second concave portions 103 as a design feature of the stamper. Here, the first concave portions 102 correspond to a bottom of the stamper. That is, the wall portions 101 of the imprint stamper form the concave portions or nonmagnetic material regions of the magnetic recording media through a manufacturing process of the magnetic recording media including imprinting. In this embodiment, one second-concave portion 103 is assigned to each first concave portion 102. Thus, first-concave portions 102 are connected with each other through second-concave portions 103. Here, one first-concave portion 102 is defined by two wall portions 101 adjacent to each other. In this embodiment, each first concave portion 102 is rectangular in shape, and is mostly surrounded by 4 faces of two wall portions 101 adjacent to each other. Two adjacent first-concave portions 102 are connected with each other through one second-concave portion 103. That is, second concave portions 103 are provided around at two ends of a diagonal line segment of one first concave portion 102.

Here, the stamper is made predominantly of nickel, for example.

The width of second-concave portions 103 is preferably not less than 5 nm. The depth of second concave portions 103 is also preferably not less than 5 nm. These dimensions are required to ensure sufficient flowing paths for molecules of a photoresistive resin (referred to as a “resist”) to flow through second concave portions 103. Here, the width of second concave portions 103 means a gap length between one circumferential wall portion 1011 and radial wall portions 1012 of the wall portion 101 adjacent to one circumferential wall portion 1011. The depth of second concave portions 103 also means a height of wall portions 101.

When an entire circular track is taken into account, one second-concave portion 103 is periodically assigned to each first-concave portion 102 on the circular track. The second-concave portions 103 and the first-concave portions 102 form a continuous flow path along the circular track as a whole in the embodiment. The path is supposed to flow a photosensitive resin (a resist) while imprinting using the stamper according to the embodiment. Therefore, assigning two or more second concave portions 103 to each first concave portion 102 may be more preferable for flowing a resist more smoothly through a pattern of the imprint stamper. On the contrary, when the number of the second-concave portions 103 assigned to each first-concave portion 102 is reduced, two adjacent first-concave portions 102 tend to be more isolated from each other. Therefore, recording bits thus obtained using the stamper are more isolated magnetically from each other, being more tolerant of thermal fluctuations between respective recording bits. When trade-off between smoothness of the resist flowing and tolerance of thermal fluctuations of the recording bits is taken into consideration, it is preferable to assign one second-concave portion 103 to each first-concave portion 102.

### Modified Examples for Imprint Patterns of the Stamper According to the First Embodiment

In addition, imprint patterns of the stamper are not limited to the above mentioned in the embodiment. Namely, the imprint pattern of the stamper according to the invention should just have the first and second concave portions 102 and 103, and the wall portions 101,

the first concave portions 102 defining the recording bits;
the second concave portions 103 being provided in the front of the ends of the radial wall portions 1012;
the wall portions 101 separating the first concave portions 102 from each other.
And it is more preferable that two or more second-concave portions 103 are assigned to each first-concave portion 102 to form a smoother flow path for a resist through all the first-concave portions 102 on a circular track.

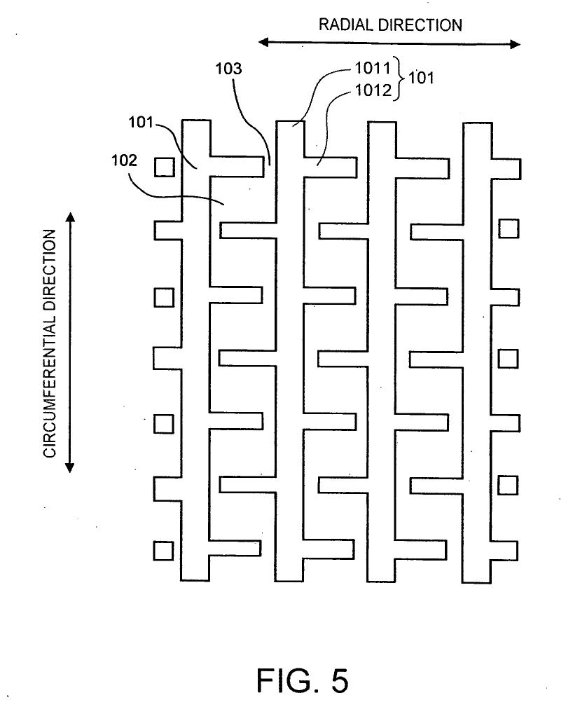

For example, various imprint patterns of the stamper are exemplified in FIGS. 5 to 14. FIGS. 5 to 14 are plan views showing modified imprint patterns of the stamper according to the first embodiment of the invention.

The first-concave portions 102 and the second-concave portions 103 in the imprint pattern shown in FIG. 5 are the same as those shown in FIG. 2 regarding their shapes and mutual positions. Just shapes of the wall portions 101 defining the first and second concave portions 102 and 103 shown in FIGS. 2 and 5 are different from each other. In FIG. 2, a plurality of radial wall portions 1012 and a circumferential wall portion 1011 form a series of crosses, whereas the extending of a plurality of radial wall portions 1012 from one circumferential wall portion 1011 alternates from side to side as shown in FIG. 5.

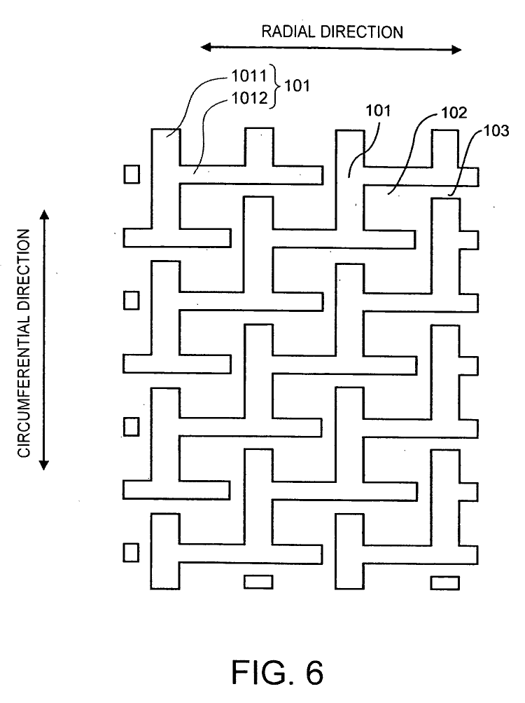

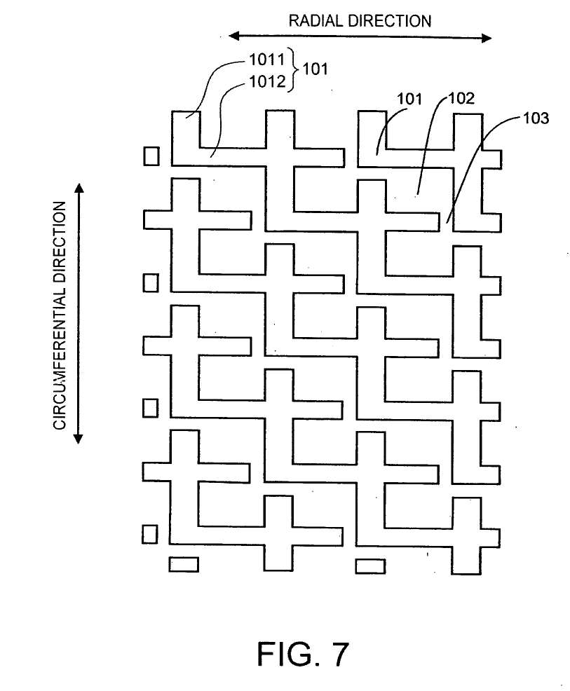

In the pattern shown in FIG. 6, one short circumferential wall portion 1011 and one short radial wall portion 1012 are combined to form a “reverse T-type” wall portion. The reverse T-type wall portions are further combined with each other step by step, diagonally on the upper right-side to build up an entire wall portion 101 as shown in the figure. A plurality of the entire wall portions 101 align regularly to define the first and second concave portions 102 and 103, and also form continuous flow paths for a resist as a result. The paths appear to run diagonally on the upper right-side as a whole. In the pattern shown in FIG. 7, a short circumferential wall portion 1011 and a short radial wall portion 1012 are combined to form an “L-type” wall portion. The L-type wall portions are further overlapped so that one circumferential wall portion 1011 and one radial wall portion 1012 of the two adjacent L-type wall portions cross with each other, forming an entire wall portion 101 as shown in the figure. A plurality of the entire wall portions 101 align regularly to define the first and second concave portions 102 and 103, and also form continuous flow paths for a resist as a result. The paths appear to run diagonally on the upper left-side as a whole.

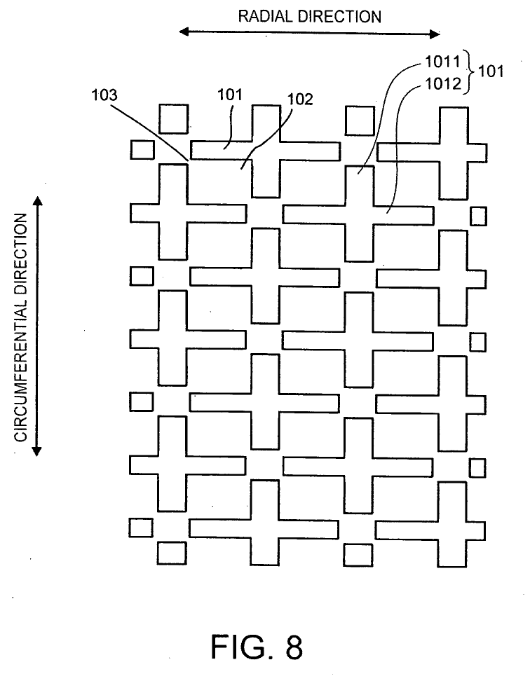

In the imprint pattern shown in FIG. 8, an entire wall portion 101 is of a cross type, the two circumferential and radial wall portions 1011 and 1012 crossing with each other. The entire wall portions 101 are arranged two-dimensionally, defining first and second concave portions 102 and 103 as a result. Second concave portions 103 are formed as a gap space between two wall portions 101 diagonally adjacent to each other as shown in the figure. Continuous flow paths appear to run in the two diagonal directions of rectangular first-concave portions 102, allowing a resist to flow through the pattern more smoothly.

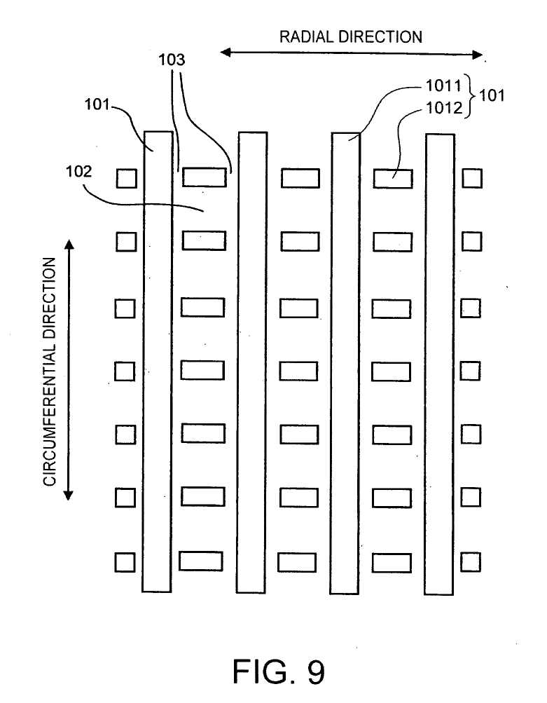

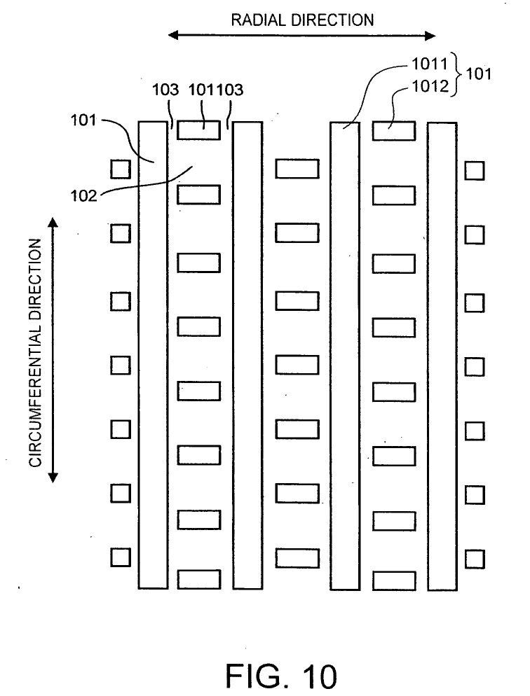

In the imprint pattern shown in FIG. 9, long circumferential wall portions 1011 align laterally at a constant interval, and short radial wall portions 1012 align vertically at a constant interval between two adjacent wall portions 1011. Adjacent lateral alignments of the portions 1012 are also in step with each other. In the imprint pattern shown in FIG. 10, long circumferential wall portions 1011 and short radial wall portions 1012 are arranged in a similar way to those in FIG. 9. However, adjacent lateral alignments of the portions 1012 shift from each other by a half vertical period as shown in FIG. 10. In FIGS. 9 and 10, an entire wall portion 101 is formed of two kinds of detached portions. Circumferential and radial portions of the entire portions 101 define first and second concave portions 102 and 103 as well as in the figures mentioned above, resulting in more straight-line paths to allow a resist to flow more smoothly. Two second concave portions are assigned to each first-concave portion in the patterns shown in FIGS. 9 and 10.

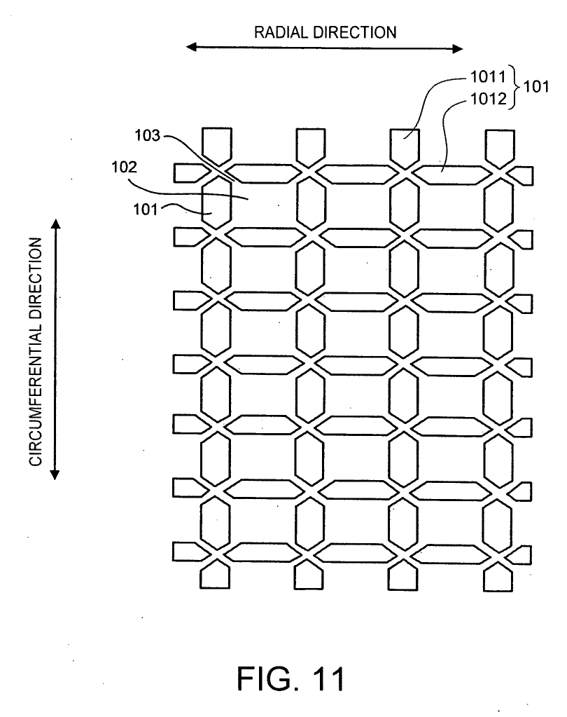

In the imprint pattern shown in FIG. 11, both circumferential and radial wall portions 1011 and 1012, which are hexagonal in shape, are arranged vertically and horizontally, respectively, to form an entire wall portion 101. The entire wall portion 101 defines first and second concave portions 102 and 103 so as to form a finely meshed pattern as a whole. All first-concave portions 102 are connected with each other through second-concave portions 103 in two diagonal directions, thus forming continuous flow paths of an “X-type” in the imprint pattern, resulting in much smoother resist flow. Eight first concave portions 102 surrounding a certain first-concave portion 102 are connected with each other through the X-type paths as shown in FIG. 11, there exist more paths for a resist, resulting in a much smoother resist flow. The stamper shown in FIG. 11 has a feature that two or more second concave portions 103 align on a straight line in diagonal directions of a first-concave portion 102, and two or more first concave portions 102 are connected with each other through second-concave portions 103 in the diagonal directions, differing from that in the first embodiment. This results in flowing paths of a resist over two or more first-concave portions 102 on a straight line in diagonal directions of a first-concave portion 102. The stamper allows a resist to flow much more smoothly.

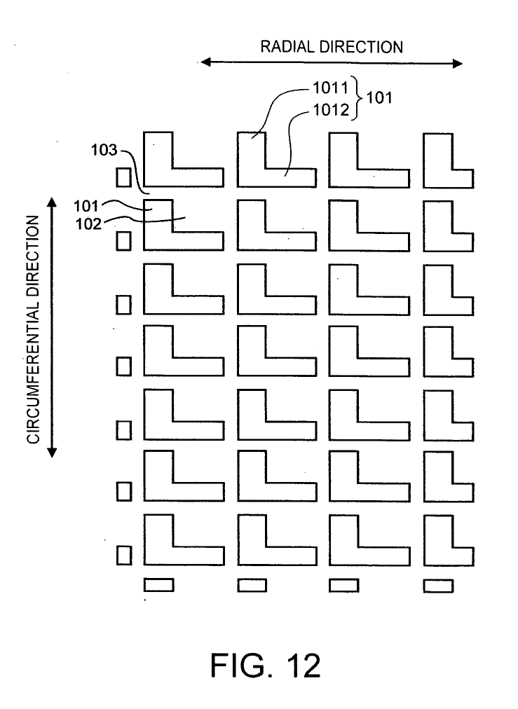

In the imprint pattern shown in FIG. 12, a circumferential wall portion 1011 and a radial wall portion 1012 are combined to form an L-type wall portion 101 entirely. The L-type wall portions 101 are arranged two-dimensionally to form the imprint pattern. Two second concave portions 103 are assigned to each first-concave portion 102, which is defined as a rectangular area by regularly aligned L-type wall portions 101, differing from the stamper of the first embodiment. The L-type wall portions 101 thus arranged two-dimensionally define first and second concave portions 102 and 103 as shown in FIG. 12. One first concave portion is connected with adjacent 4 first concave portions through 4 second concave portions as resist flow paths as shown in the figure. That is, the imprint pattern includes more continuous flow paths running straight in vertical and horizontal directions as shown in FIG. 12. In the stamper,

(1) two or more second-concave portions 103 are arranged on a straight line in a circumference direction;
(2) two or more first-concave portions 102 adjacent to each other in a circumference direction are connected with each other;
(3) two or more second-concave portions 103 are arranged on a straight line in a radial direction; and
(4) two or more first-concave portions 102 adjacent to each other in a radial direction are connected with each other through the second-concave portions 103.
Hence, the stamper shown in FIG. 12 differs from that of the first embodiment in the above four points. The straightforward alignments of second-concave portions 103 provide straight paths to allow a resist to flow much more smoothly in both circumferential and radial directions.

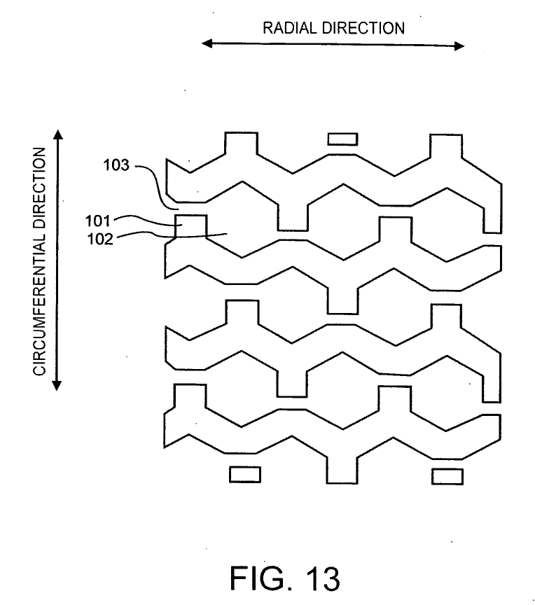

In the stamper shown in FIG. 13, a first-concave portion 102 is hexagonal in shape, differing from that in the first embodiment with a rectangle shape.

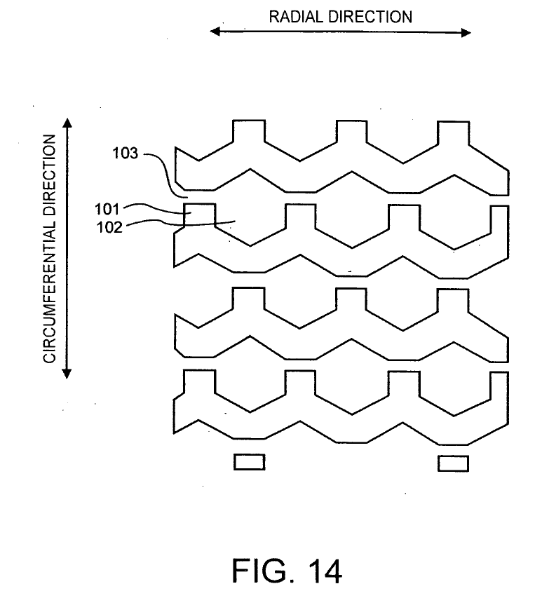

In the stamper shown in FIG. 14, a first-concave portion 102 is hexagonal in shape, differing from that of the first embodiment including rectangular first-concave portions. The stamper shown in FIG. 14 has an imprint-pattern configuration where two or more second-concave portions 103 are arranged on a straight line in a radial direction, and the two or more first-concave portions 102 are connected with each other in the radial direction through second-concave portions 103, differing from that of the first embodiment. The configuration described above allows a resist to flow over two or more first and second concave portions smoothly on the stamper shown in FIG. 14.

As described above, the specific imprint-patterns of the stampers according to the invention have been illustrated in FIGS. 5 to 14. However, the examples are not limited to these. For example, the first-concave portions 102 have been exemplified to be rectangular or hexagonal in shape. However, shapes of the first-concave portions 102 are not limited to these. The shapes may be polygons including triangles, quadrangles and pentagons, etc.

### First Manufacturing Process of Stampers According to The First Embodiment

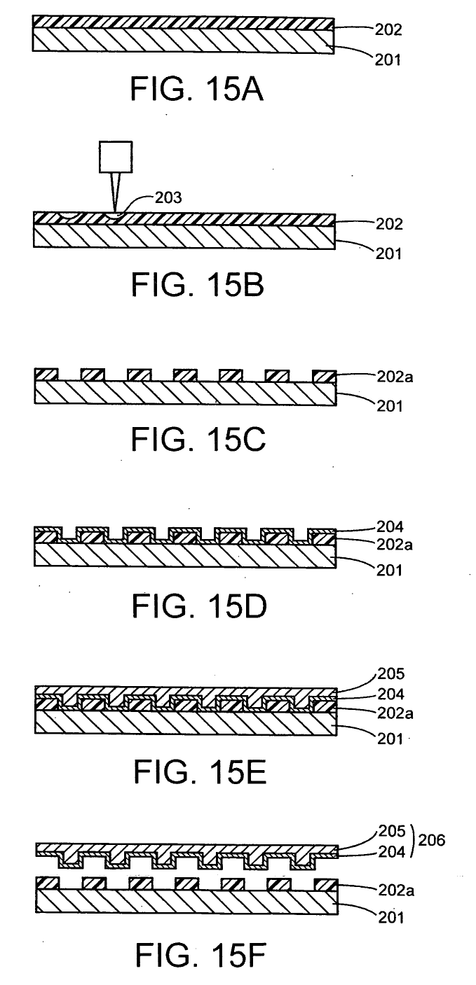

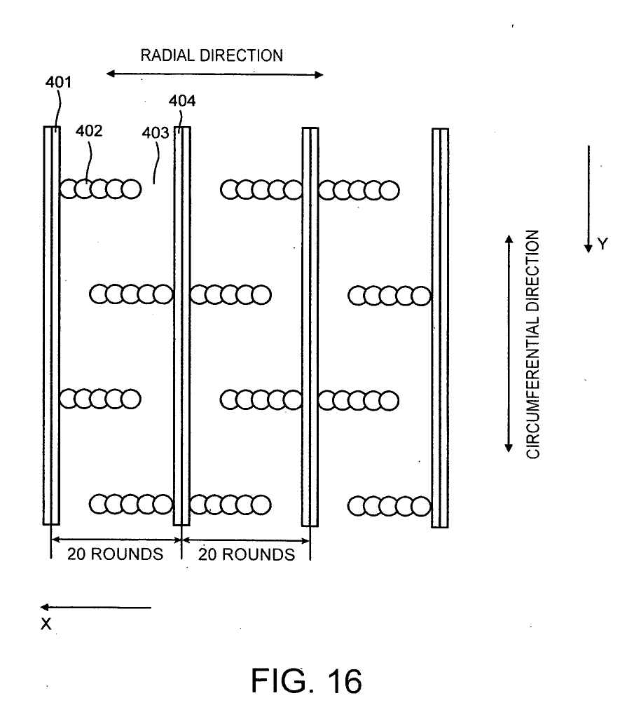

Next, a first manufacturing method of the stamper according to the embodiment is explained with reference to FIGS. 15A to 16. FIGS. 15A to 15F are sectional views serially showing the first manufacturing method of the stamper according to the embodiment. FIG. 16 is a plan view showing an exposed pattern of an exposure process of the first manufacturing method of the stamper according to the embodiment. The first manufacturing method of the stamper according to the embodiment includes:

forming a photosensitive resin film 202, for example, a positive type resist, on a substrate 201;
drawing a pattern by exposing the positive type resist 202;
developing the positive type resist 202;
forming a conducting film 204 on the positive type resist 202 and the substrate 201;
forming the electroformed film 205 on the conducting film 204; and
removing the conducting film 204 and the electroformed film 205 from the substrate 201 and the positive type resist 202.
The conducting film 204 and the electroformed film 205 are removed as one unit from the substrate 201 and the positive type resist 202 to provide a stamper.

Here, in the first manufacturing method of the stamper according to the embodiment, the shape of the substrate 201 for an original disk is not limited in particular. However, a disk-shaped thing, e.g., a silicon wafer is preferable. The substrates 201 include a glass substrate, an aluminum system alloy substrate, a ceramic substrate, a carbon substrate, a compound semiconductor substrate, etc. Amorphous glass includes soda lime glass, aluminosilicate glass, etc. Crystallized glass includes lithium system crystallized glass etc. Ceramic substrates include sintered compacts made predominantly of aluminum oxide, aluminum nitride, silicon nitride and fiber-reinforced sintered compacts, etc. Compound semiconductor substrates include GaAs, AlGaAs, etc.

First, as shown in FIG. 15A, all over the top surface of the substrate 201 is coated with a positive type resist 202. A 6-inch Si wafer is prepared for the substrate 201. In order to improve the adhesion of the resist 202 to the substrate 201, the Si wafer of the substrate 201 is surface-treated in advance with hexamethyldisilazane (HMDS). Next, a resist ZEP-520 manufactured by ZEON Corporation was diluted twice with anisole, followed by filtering with a 0.2-μm-pore membrane filter to provide a resist solution. The Si wafer of the substrate 201 was spin-coated with the resist solution. The wafer was then pre-baked at 200° C. for three minutes, thus forming the resist 202 with a thickness of 75 nm. The thickness of the resist 202 is set so that concave portions of the resist pattern 202a formed in a subsequent process can maintain their shapes sufficiently. For example, the film thickness of the resist 202 is preferably 20 nm or more and 200 nm or less.

Next, as shown in FIG. 15B, the exposure pattern (latent-image) 203 is drawn by exposing the resist 202 formed on the Si wafer of the substrate 201. An EB drawing apparatus is used for the EB exposure in the embodiment. The apparatus is provided with a moving mechanism which moves a stage, on which the substrate 201 with the resist 202 thereon is put, in one horizontal direction, and a rotating mechanism which rotates the stage. The EB drawing apparatus has an electron beam column with acceleration voltage of 50 kV including an electron gun, a condenser lens, an objective lens, a blanking electrode, a deflector and an electron gun emitter of a ZrO/W thermal field emission type.

A laminated structure of the substrate 201 and the resist 202 was transported to a predetermined position in the EB drawing apparatus with a feed system thereof, being exposed under vacuum to obtain a concentric circle pattern. The concentric circles were drawn with increasing deflection intensity for each rotation.

According to the embodiment, the exposure is performed by irradiating the resist 202 with an EB. The exposure is conducted by drawing two or more rounds of the exposure from the inner circumference to the outer one, and vice versa, for a region corresponding to a bit pattern. For example, when irradiating the positive resist 202 with an EB, blanking operation of an EB is conducted to form the pattern. In the exposure process according to the embodiment, the resist is irradiated with an EB for a region where the wall portions 101 are supposed to be formed on the stamper. The resist is not irradiated with the EB for a region where the first and second concave portions 102 and 103 are supposed to be formed on the stamper.

The exposure is conducted under the following conditions.
Exposed portion radius: 9 mm to 23 mm
Number of sectors per track: 180
Number of bits per sector: 5000
Track pitch: 240 nm
Feed quantity per rotation: 20 nm
Number of exposure rounds per track: 20 rounds
Number of exposure rounds per track to form a circumferential groove: 2 rounds
Number of exposure rounds per track to form a radial groove: 2 rounds (15 rounds including 2 rounds for a circumferential groove)
Linear velocity: 1.1 m/s (constant)

In order to form the pattern of the stamper according to the embodiment as shown in FIG. 1, the resist is exposed to an electron beam to draw a pattern as shown in FIG. 16. In FIG. 16, the X direction represents a radially inside direction of a circumferential track, and the Y direction represents a clockwise rotation direction of the track. And the exposure is conducted by sequentially-drawing circles from the radial inside toward the radial outside. In this embodiment, exposing 20 rounds per track is conducted repeatedly to form a whole track pattern on the stamper. A process for exposing one track is explained below. In order to form the wall portion 101 running continuously in a circumference direction over two or more first-concave portions 102, the resist is exposed to an EB continuously in a circumference direction to obtain an exposure pattern 401 as shown in FIG. 16. This exposure is carried out one round. Next, in order to form the first-concave portions 102 and the radial wall portions 1012, positions of the resist corresponding to the radial wall portions 1011 are exposed to an EB at a certain interval in a circumference direction to obtain an exposure pattern 402 as shown in FIG. 16. This exposure is carried out 18 rounds in this embodiment. In order to form the second-concave portions 103 formed at leading ends of the radial wall portions 1012, positions corresponding to a small area locating in front of the leading ends of the radial wall portions 1012 are not exposed to the electron beam first 5 rounds or last 5 rounds out of the 18 rounds. This action provides non-exposure portions 403 also as shown in FIG. 16. The first and last 5-round unexposed portions 403 correspond to the second-concave portions 103. Next, in order to form the circumferential wall portion 1011 which is continuously formed in a circumferential direction of the stamper, a continuous exposure over the entire circumference is run in order to form the circumferential wall portion 1011, resulting in an exposed pattern 404 as shown in FIG. 16. This exposure is run 1 round. The exposure pattern for one track can be formed by running 20 rounds of the above exposures. By repeating the above process, an entire exposure pattern of the stamper is formed as shown in FIG. 16.

Exposure conditions are not limited to the above-described. For example, the following conditions are preferable as exposure conditions.

As exposure conditions, a narrow track pitch and a narrow bit pitch are preferable for a high storage density. The drawing is required to complete one track-pattern by several rounds to tens of rounds. This is because nonmagnetic portions and magnetic portions are required to be formed, the nonmagnetic portions separating a plurality of the recording bits, the magnetic portions forming the recording areas. This is also because the address areas 22 and burst areas 23 are required to be formed in the corresponding servo area. Here, it is preferable to complete one track with 6 rounds or more to 36 rounds or less. The round number of the exposure more than a certain number for one track provides a higher shape-resolution of the imprint pattern, reflecting a precise imprint pattern on the stamper. The round number of the exposure less than a certain number provides simplifications and smaller capacities of the servo signal, and frees an excessively precise control from feeding and rotating mechanisms of the EB drawing apparatus. It is more advantageous for a design of the imprint pattern that the round number has as many devisors as possible.

An in-plane film speed for the resist film to be exposed is normally uniform. It is thus preferable to rotate the rotating stage of the system with the linear velocity constant.

When a track in a one-user data area has a pitch of 240 nm, patterning one track with 20 rounds of the exposure yields a feed per rotation of 12 nm that equals 240 nm/20. It is preferable that the feed per rotation is below the beam diameter in order to eliminate insufficiently exposed areas or undeveloped portions.

Regarding a stage, an optical system for scanning an EB and signals for actuating the system in the EB drawing apparatus, it is at least required that a blanking point and a blanking signal, a stage actuating signal for movement control in a radial direction and in a rotational direction are synchronized with one another.

Next, the laminated structure of the silicon substrate 201 and the exposed resist 202 is developed as shown in FIG. 15C. This development forms a resist pattern where the resist 202 is removed from the exposed area of the resist 202 to form concave portions, the unexposed area thus corresponding to convex portions. Here, the resist 202 may be removed completely for the concave portions and the substrate may be revealed in the bottoms of the concave portions. The laminated structure of the silicon substrate and the exposed resist is developed by dipping the laminated structure in developer (for example, ZED-N50 (produced by NIPPON ZEON Co., Ltd.)) for 60 seconds. The laminated structure thus developed is then rinsed by dipping the structure in rinsing liquid (for example, ZMD-B (NIPPON ZEON Co., Ltd.)) for 60 seconds. The rinsing is followed by air blowing to dry. The above steps result in a resist original disk provided with the substrate 201 and the resist pattern 202a formed on the substrate 201.

Next, a thin conducting film 204 is formed on the resist original disk thus developed, as shown in FIG. 15D. The conducting film 204 is formed by sputtering so as to have a film thickness of 15 nm, for example. In the sputtering, pure Ni is employed for a target material, for example. A sputtering chamber is evacuated by 8×10⁻³ Pa, and then an Ar gas is introduced in the chamber up to 1 Pa. Under an Ar gas pressure of 1 Pa, the Ni film is sputtered in the chamber for 20 sec by applying a 400-W DC power.

Next, as shown in FIG. 15E, an electroformed film 205, e.g., a nickel film is formed by electroforming on the resist original disk with the above-mentioned conducting film 204 formed thereon. The electroformed film 205 with a thickness of 280 μm is formed, for example. The electroforming is carried out by immersing the resist original disk with the conducting film 204 thereon in a nickel sulfamate bath.

The following conditions are adopted for the electroforming nickel sulfamate bath.

Nickel sulfamate: 600 g/L

Boric acid: 40 g/L

Surface-active agent (sodium lauryl sulfate): 0.15 g/L

Temperature of liquid: 55° C.

PH: 4.0

Current density: 16 A/dm²

Next, as shown in FIG. 15F, the conducting film 204 and the electroformed film 205 are removed as a unit from the resist original disk. As a result, a stamper 206 is acquired to be provided with the conducting film 204, the electroformed film 205 and a resist residue.

The resist residue adhered to the conducting film 204 and the electroformed film 205 is removed by oxygen plasma ashing. Specifically, an oxygen gas is introduced into an ashing chamber at 100 ml/min, and the oxygen pressure in the chamber is adjusted to 4 Pa. Then, 100-W power is applied to carry out plasma ashing for 20 minutes in the chamber.

According to the above process, a father stamper 206 with the conducting film 204 and the electroformed film 205 is acquired. Subsequently, the unnecessary portions of the farther stamper are punched off using a metal blade to obtain an imprint stamper.

The stamper is subjected to ultrasonic cleaning with acetone for 15 minutes. The stamper is treated as noted below, in order to improve releasability while imprinting. A solution of fluoroalkylsilane diluted with ethanol to a concentration of 5% is prepared. The stamper 8 is immersed in the solution for 30 minutes, followed by blowing away the residual solution using a blower, and then the stamper is annealed at 120° C. for one hour.

The imprint stamper according to the first embodiment as shown in FIG. 1 is formed through the above manufacturing process.

### The Second Manufacturing Process of the Stamper According to the First Embodiment

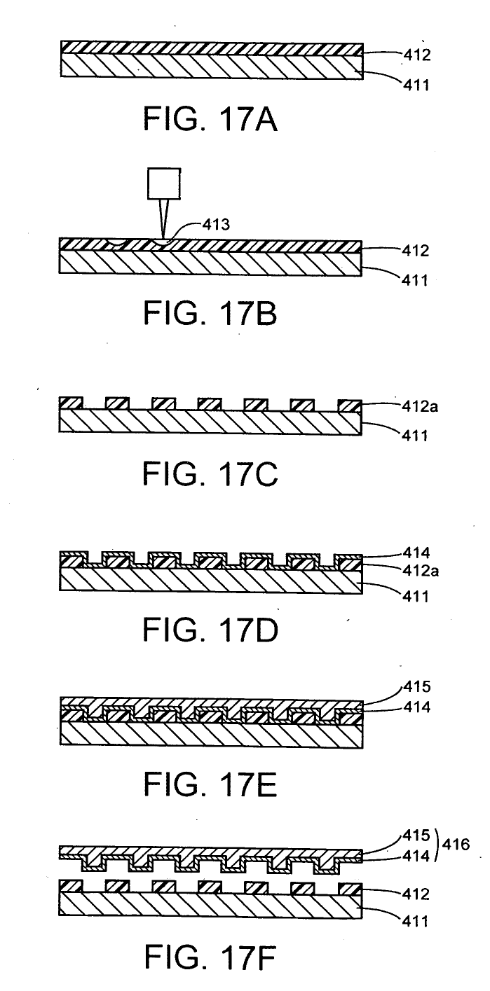

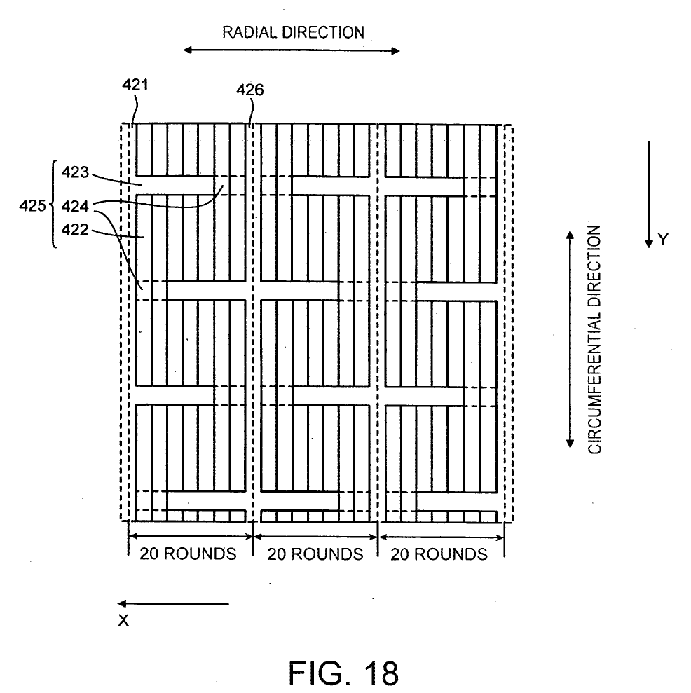

The second manufacturing method of the stamper according to the first embodiment is explained with reference to FIG. 17A to FIG. 18. FIGS. 17A to 17F are sectional views showing the second manufacturing process of the stamper according to the first embodiment. FIG. 18 is a plan view showing an exposure pattern in an EB exposing step of the second manufacturing process of the stamper according to the first embodiment. The manufacturing method of the stamper according to the embodiment includes the following steps:
forming a resist 412 of a negative type on a substrate 411 (shown in FIG. 17A);
drawing an exposure pattern 413 on the resist 412 of a negative type (shown in FIG. 17B);
developing the resist 412 of a negative type to form a resist pattern 412a (shown in FIG. 17C);
forming a conducting film 414 on the substrate 411 and the resist pattern 412a (shown in FIG. 17D);
forming an electroformed film 415 on the conducting film 414 (shown in FIG. 17E); and
removing a stamper 416 with the conducting film 414 and the electroformed film 415 from the substrate 411 and the resist of a negative type 412 (the resist pattern 412a) (shown in FIG. 17F).
   The conducting film 414 and the electroformed film 415 which were removed as a unit from the substrate 411 and the negative type resist 412, serving as the stamper 416.

Exposing and developing in the above-described manufacturing process of the imprint stamper are explained below. When a negative type resist is used, non-exposure areas are removed by developing after exposing. This differs from the case using a positive type resist in a point that exposed areas are removed by developing after exposing. Exposing process using a negative type resist differs from that using a positive type one in a manufacturing process of an imprint stamper. Exposing patterns are mutually inverted between the cases using positive and negative type resists.

As shown in FIG. 17B, the exposing pattern (latent image) 413 is drawn by exposing the negative type resist 412 formed on the Si wafer substrate 411. In the exposing of the embodiment, areas of the resist 412, where the first and second concave-portions 102 and 103 are supposed to be formed, are exposed to an EB. On the other hand, areas of the resist, where the wall portions 101 are supposed to be formed, are not exposed to an EB.

The exposing is conducted under the following conditions, for example.
Exposed portion radius: 9 mm to 23 mm
Number of sectors/track: 180
Number of bits/sector: 5000
Track pitch: 240 nm
Feed amount per round: 12 nm
Number of exposure rounds per track: 20 rounds
Number of non-exposure rounds per track for forming a groove in the circumference direction: 2 rounds
Number of non-exposure rounds per track for forming a groove in the radial direction: 13 rounds (totally 15 rounds including 2 rounds of non-exposure for forming a groove in the circumference direction)
Linear velocity: 0.9 m/s (constant)
   As exposing conditions, the first manufacturing process differs from the second one in exposure and non-exposure areas. The second manufacturing process has 2 rounds of non-exposures for forming a groove for each track in the circumference direction, whereas the first manufacturing process has 2 rounds of exposures for the same reason, being quite different from each other. The second manufacturing process has 13 rounds of non-exposures for forming a groove for each track in the radial direction, whereas the first manufacturing process has 13 rounds of exposures for the same reason, being quite different from each other. Moreover, the first manufacturing process differs from the second one in the linear velocity.

In order to form the pattern of the stamper according to the embodiment as shown in FIG. 1, the resist is exposed to an EB to draw a pattern as shown in FIG. 18. The X-direction expresses a radially inner direction, whereas the Y-direction expresses a clockwise rotational direction of the circumference in FIG. 18. And the exposing is carried out from the inner toward the outside so as to draw circles. In this embodiment, a pattern is formed by sequentially exposing 20 rounds per track. A process of exposing per track is explained below. A non-exposure area is provided continuously in the circumferential direction to form a line pattern 421 as shown in FIG. 18, corresponding to the circumferential wall portion 1011. The line pattern is formed sequentially to provide a plurality of the circumferential wall portions 1011 on the stamper according to the embodiment, defining the first concave portions 102 together with the radial wall portions 1012. This non-exposure process is carried out one round. In order to form the first concave portions 102, second concave portions 103 and radial wall portions 1012, areas corresponding to the first and second concave portions 102 and 103 are exposed to an EB (denoted as 422 and 424, respectively, in FIG. 18), whereas areas corresponding to the radial wall portions 1012 are not exposed to an EB (denoted as 423 in FIG. 18). This process provides an exposure pattern 425 as shown in FIG. 18. This exposure is carried out 18 rounds. In order to form the second concave portions 103, 5 rounds of 18-round exposures are carried out in the front of the leading edges of the areas 423 corresponding to the radial wall portions 1012, being denoted as 424 in FIG. 18. Thus, the 5 rounds of exposures in the front of the leading edges of the areas 423 corresponding to the radial wall portions 1012 allows it to provide the second concave portions 103 around at two ends of a diagonal line segment of the first concave portion 102. That is, the second concave portions 103 can be provided to the two ends of a diagonal line segment of the first concave portion 102 in such a case as shown in FIG. 18. Next, a non-exposure line pattern 426 is formed to provide the stamper with a circumferential wall portion 1011, defining the adjacent track. This non-exposure process is carried out one round. As described above, the one-track pattern can be formed by carrying out 20 rounds of the exposures. By repeating the above processes, an exposure pattern is formed as illustrated in FIG. 18.

Next, as shown in FIG. 17C, the resist pattern 412a is formed by developing the laminated structure with the exposed resist on the silicon substrate. That is, the non-exposure portions are removed to form concave portions, the exposure portions of the resist 412 forming convex portions.

### Manufacturing Process of the Magnetic Recording Medium According to the First Embodiment

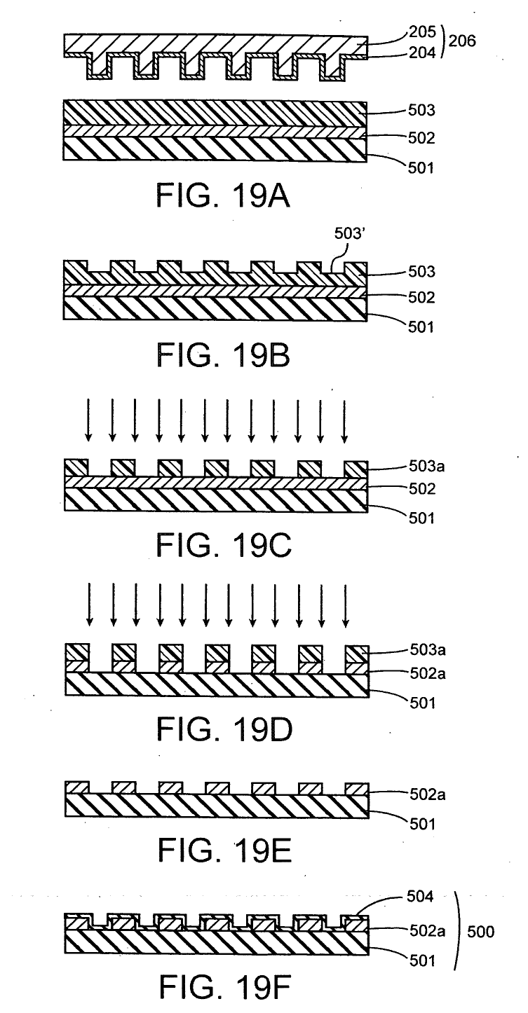

A manufacturing process of the magnetic recording medium according to the first embodiment using the imprint stamper formed through the above-mentioned process according to the first embodiment is explained with reference to FIGS. 19A to 19F. FIGS. 19A to 19F are sectional views showing the manufacturing process of the magnetic recording medium according to the first embodiment.

A laminated structure is formed as shown in FIG. 19A. The structure is provided with a substrate 501 to be processed, a magnetic recording layer 502 and a photosensitive resin, e.g., a resist 503. The magnetic recording layer 502 is formed by sputtering on the substrate 501, e.g., a doughnut type glass substrate 501 with a diameter of 0.85 inch, and the recording layer 502 is spin-coated with a novolac-base resist at a rotational velocity of 3800 rpm, forming the resist 503 on the magnetic recording layer 502. As a material for the magnetic recording layer 502, CoPt or FePt is employed, for example. Here, the viscosity of the resist 503 is preferably 10 cp or less, and is more preferably 5 cp or less. This is because that the viscosity of the resist 503 is sufficiently low so that the resist is easy to flow while imprinting when the viscosity of the resist 503 is 10 cp or less. Making the resist easy to flow during imprint allows the resist to flow through the second concave portions 103 even when the second concave portions 103 are narrow or shallow, or even when the number of the second concave portions 103 is small. When the stamper is manufactured by making the second concave portions 103 narrow and shallow and by reducing the number of the second concave portions 103, the influence of thermal fluctuations to occur between respective recorded bits can be suppressed in the magnetic recording medium. Moreover, the viscosity of the resist is more preferably 5 cp or less in order to make the resist easier to flow.

Next, the resist 503 is provided with a concavo-convex pattern having concave portions 503′ (fifth concave portions), as shown in FIG. 19B, by imprinting the pattern of the stamper according to this embodiment onto the resist 503. The imprinting is conducted by pressing the stamper at a pressure of 2000 bar for 1 minute. The stamper according to this embodiment is provided with wall portions 101 so that two or more first concave portions 102 are surrounded by the wall portions 101 in order to define two or more recording bits 32 of the magnetic recording medium. Here, a first concave portion 102 is rectangular in shape and is surrounded by 4 faces of the wall portions 101. And, one second-concave portion 103 is assigned to each first concave portion 102. Thus, the first-concave portions 102 are connected with each other through the second-concave portions 103. Therefore, although the resist in one first concave portion 102 is basically surrounded by 4 faces of the wall portions 101, the resist can outflow through two second concave portions 103 into the two adjacent first concave portions 102 when the imprinting is carried out using the stamper according to the embodiment. That is, the resist can flow over two or more first concave portions 102 through second concave portions 103 connecting the first concave portions 102. The resist capable of flowing over two or more first concave portions 102 as described above allows it to imprint uniformly, and to reduce imprinting pressures and nonuniformity of imprinted patterns. The second concave portions 103 assist in inflowing of the air between the stamper to be removed and the resist of the original disk when removing the stampers. This assist can suppress a portion of the resist adhering to the stamper, thus preventing the portion from being removed along with the stamper. This can also prevent recording bits 32 supposed to be formed on the resist from being entirely removed from the stamper.

After imprinting followed by UV-irradiating the resist with a pattern imprinted for 5 minutes, the resist is hardened by heating at 160° C. for 30 minutes.

Next, as shown in FIG. 19C, the pattern imprinted on the resist 503 is used as a mask to form the resist pattern 503a where the concave portions 503′ of the resist with the pattern imprinted is etched to dig out the magnetic recording layer 502 at the portions 503′. RIE is conducted to etch under an oxygen pressure of 2 mTorr, e.g., using an inductively coupled plasma etching apparatus.

As shown in FIG. 19D, the magnetic recording layer 502 is etched by Ar ion milling using the patterns of the resist 503a as a mask. The portions dug out of the magnetic layer 502 is carved perpendicularly to the substrate by ion milling, e.g., Ar-ion milling.

Next, as shown in FIG. 19E, the resist pattern 503a is removed using a dry etching or some chemicals to form the recording bits 502a. The recording bits 502a consist of two or more convex magnetic layers arranged so as to correspond to the pattern of two or more first concave portions 102 of the imprint stamper. As the etching, oxygen RIE is conducted under a power application of 400 W and a pressure of 1 Torr, for example.

Next, as shown in FIG. 19F, a protective film 504 is formed all over the substrate 501 with the recording bits 502a thereon to complete the magnetic recording medium 500. A diamond like carbon film with a thickness of 3 nm is formed as the protective film 504 by a chemical vapor deposition. Furthermore, a lubricant with a thickness of 1 nm is provided to the medium 500 by a dip method.

By the above manufacturing process, the magnetic recording medium 500 according to the first embodiment is provided.

The magnetic recording medium 500 provided by the above manufacturing process is built into the magnetic recording apparatus 10. Read/write of magnetic signals to the data area of the medium 500 resulted in good write-in and read-out of the signals.

In the manufacturing process shown in this embodiment, after the step of FIG. 19E and before the step of FIG. 19F, nonmagnetic materials such as SOG (Spin on glass), etc. may be provided to fill up concave portions between the recording bit 502a and the recording bit 502a, allowing it to provide the magnetic recording medium with an entirely flat surface.

As shown in FIG. 19F, the magnetic recording medium 500 provided by the above manufacturing process has a pattern of which concavity and convexity is inverted in comparison with the pattern of the stamper 206. The magnetic recording medium 500 provided by the above manufacturing process is provided with two or more recording bits 502a formed on the substrate 501 and the concave portions separating the recording bits 502a from each other. And, the recording bits 502a are configured to correspond to the pattern of the first concave portions 102 of the stamper according to this embodiment. The concave portions separating the recording bits 502a from each other are configured to correspond to the pattern of the wall portions 101 of the stamper according to this embodiment. The concave portions of the magnetic recording medium 500 according to the embodiment include concave magnetic portions corresponding to the second concave portions 103. The magnetic portions may be reduced to disappear during the manufacturing process with etching, ion milling, etc. after imprinting the resist pattern using the stamper according to the embodiment. As a result, no magnetic portion could be formed in the concave portions of the magnetic recording medium in some cases.

Here, the magnetic recording medium has a disk shape, preferably a doughnut type in particular due to a principle for the use of the medium, whereas the size of the medium is not particularly limited due to the principle. However, it is preferable that the disk size is 3.5 inches or less so that the time for the electron-beam drawing may not be too long. Furthermore, it is also preferable that the size of the disk is 2.5 inches or less so that the imprinting pressure may not be too high. It is more preferable that the disk size is less than 2.5 inches, e.g., 0.85 inch or 1.8 inches, so as to make the drawing time shorter and to make the imprinting pressure lower for mass productions. Moreover, the medium may have one surface or both surfaces for the recording area.

### Comparative Example of the Stamper According to the First Embodiment

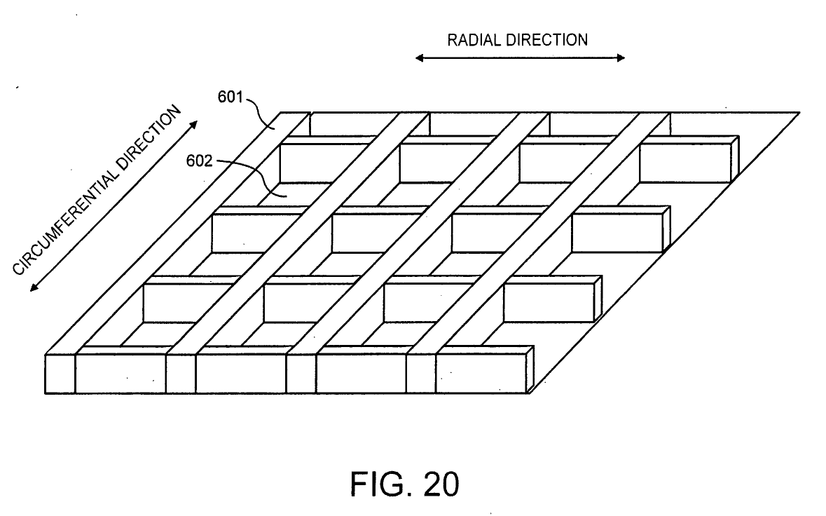

Next, in order to explain the effect of the stamper according to this embodiment, a stamper according to a comparative example is shown in comparison with the stamper according to the embodiment. FIG. 20 is a perspective view showing the stamper according to the comparative example. As shown in FIG. 20, the stamper according to the comparative example differs from that according to the embodiment in a point that the second concave portions are not provided to the wall portions formed so as to separate two or more first concave portions from each other.

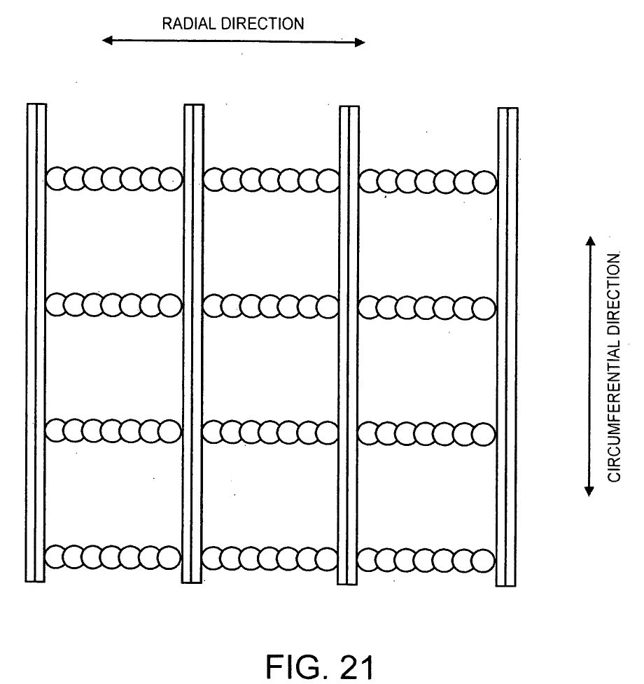

Next, the manufacturing process of the stamper according to the comparative example is explained. The manufacturing process of the stamper according to the comparative example is the same as that of the stamper according to the first embodiment, except for the exposure process. FIG. 21 is a plan view showing an exposure pattern of the exposure process in the manufacturing process of the stamper according to the comparative example.

The exposure was conducted under the following conditions.
Radius of exposed portion: 9 mm to 23 mm
Number of sectors/track: 180
Number of bits/sector: 5000
Track pitch: 240 nm
Feed amount per revolution: 12 nm
Number of exposure rounds per track: 20 rounds
Number of circumferences exposed to form circumferential grooves per track: 2 rounds
Number of circumferences exposed to form radial grooves per track: 18 rounds (20 rounds in total including 2 rounds for forming circumferential grooves)
Linear velocity: 1.1 m/s (constant)
   The exposure process for the stamper according to the comparative example differs from that for the stamper according to the first embodiment in the number of circumferences exposed to form the radial grooves per track. The conditions other than the number are the same. The number of circumferences exposed to form the radial grooves per track is 13 rounds (15 rounds in total including 2 rounds for the circumferential grooves) in the manufacturing process of the stamper according to the first embodiment, whereas the number is 18 rounds (20 rounds in total including 2 rounds for the circumferential grooves) in the manufacturing process of the stamper according to the comparative example. The numbers are different from each other. That is, 5 rounds of 18-round exposures are not exposed to form the second concave portions in the manufacturing process of the stamper according to the first embodiment, whereas no rounds of 18-round exposures are exposed in the manufacturing process of the stamper according to the comparative example as shown in FIG. 21. As a result, the second concave portions are not provided to the stamper according to the comparative example, differently from the stamper according to the first embodiment.

A magnetic recording medium was manufactured using the stamper provided by the above manufacturing process in the same way as the manufacturing process according to the first embodiment. A laminated structure was formed in the same way as the manufacturing process according to the first embodiment, the structure being provided with the substrate 501 to be processed, the magnetic recording layer 502, and the resist 503. A pattern of the stamper according to the comparative example was imprinted on the resist 503 by imprinting. The stamper was removed from the laminated structure with the substrate 501 to be processed, the magnetic recording layer 502 and the resist 503 after the imprinting. Then the stamper was checked by an oblique illumination inspecting machine to observe brightly reflecting shinny points. Such shinny points are never observed normally on a flat surface using the machine. The resist pattern after imprinting was checked also using an AFM to find out defect points. The defect points were found as follows. Some of dots in the data area became defects including a whole set of the dots, or some of dots dropped out to become imperfect to be smaller than the designed. As mentioned above, the stamper according to the comparative example is not provided with the second concave portions. For this reason, nothing assists in inflowing of the air between the stamper to be removed and the resist when removing the stamper. Thus, a portion of the resist was removed together with the portion adhered to the stamper, resulting in a lack of areas of the resist being supposed to constitute the recording bits to be a problem.

The magnetic recording medium was provided using the stamper according to the comparative example as well as using the manufacturing process according to the first embodiment. The medium thus provided was built into the magnetic recording apparatus. Read/write of magnetic signals to the data area of the medium caused some failures in write-in and read-out of the signals.

When a stamper without the second concave portions like the stamper according to the comparative example is used, nothing assists in inflowing of the air between such a stamper to be removed and a resist while removing the stamper. Thus, a portion of the pressed resist is apt to be removed owing to adherence of the portion to the stamper, resulting in a lack of areas of the resist being supposed to constitute the recording bits to be a problem.

Moreover, according to the imprint stamper of the comparative example shown in FIG. 20, the first concave portion 602 is surrounded closely by 4 faces of the wall portions 601. The second concave portions are not provided to the 4 faces of the wall portions 601. Therefore, when the resist is surrounded by the 4 faces of the wall portions 601 tightly, the resist is hard to outflow. As a result, the use of the stamper according to the comparative example will cause the following problems in some cases in comparison with the stamper according to the embodiment. That is, it is impossible to imprint uniformly such a stamper, causing nonuniformity on imprinted patterns. In addition, a higher imprinting pressure is required.

### Modified Example of the Magnetic Recording Medium According to the First Embodiment

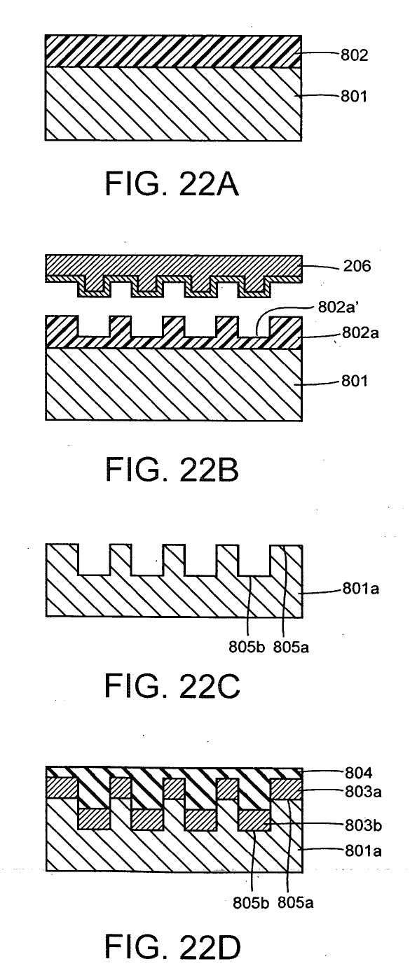

Next, a magnetic recording medium according to a modified example of the first embodiment of the invention is explained. FIG. 22D is a sectional view showing the magnetic recording medium according to the modified example of the first embodiment of the invention. The magnetic recording medium is of a “processing of a substrate” type according to the modified example of the first embodiment of the invention, differently from the magnetic recording medium being of a “processing of a magnetic substance” type according to the first embodiment. The magnetic recording medium according to the modified example has an inverted concavo-convex pattern in comparison with the medium according to the first embodiment. That is, the magnetic recording medium according to the modified example is provided with a substrate 801a having first convex portions 805a and fourth concave portions 805b thereon. Also is provided with recording bits 803a and the concave magnetic films 803b on the first convex portions 805a and the fourth concave portions 805b, respectively. And, two or more recording bits 803a are arranged so as to form a pattern of the first concave portions 102 of the stamper according to the first embodiment. The concave magnetic films formed on the fourth concave portions 805b are arranged so as to correspond to a pattern of the wall portions 102 of the stamper according to the first embodiment. Moreover, convex portions of the substrate with a pattern of the second concave portions 103 of the stamper according to the first embodiment are formed in the fourth concave portions 805b of the magnetic recording medium according to the modified example, and magnetic portions are formed on the convex portions. In addition, after imprinting the resist pattern, a pattern corresponding to the second concave portions 103 may be reduced to disappear during the manufacturing process of the magnetic recording medium with etching, ion milling, etc. In that case, the convex portions of the substrate 801a could not be formed in the fourth concave portions 805b.

FIGS. 22A to 22D are sectional views showing the manufacturing process of the magnetic recording medium according to the modified example. The manufacturing process of the magnetic recording medium according to the modified example of the first embodiment of the invention is explained below with reference to FIGS. 22A to 22D.

As shown in FIG. 22A, the resist 802 for imprinting is coated on the substrate 801. Then the laminated structure with the substrate 801 and the resist 802 is formed.

Next, the pattern of the stamper according to the first embodiment is imprinted on the resist 802 as shown in FIG. 22B. The imprinting provides a concavo-convex resist pattern 802a with a concave portion 802a′ (a third concave portion) arranged so as to correspond to the wall portion 101 of the imprint stamper. Since the stamper according to the first embodiment is used to imprint, the resist will be surrounded by 4 faces of the wall portions 101. However, the resist can outflow through the second concave portions 103 from one first concave portion to the adjacent first concave portions. That is, one second concave portion 103 connects the adjacent two first concave portions 102 in the circumferential direction, the resist flowing over two or more first concave portions. The resist capable of flowing over two or more first concave portions 102 through the second concave portions 103 allows it to imprint uniformly, and to reduce imprinting pressures and nonuniformity of imprinted patterns. The second concave portions 103 assist in inflowing of the air between the stamper to be removed and the resist of the original disk when removing the stamper. This assist can reduce a portion of the resist adhering to the stamper, thus preventing the portion from being removed along with the stamper. This can also prevent the recording bits 32 supposed to be formed on the resist from being entirely removed.

Next, the substrate 801a is provided by etching the substrate 801 using the resist pattern 802a as a mask, being provided with a concavo-convex pattern, as shown in FIG. 22C. The convex portions of the resist pattern 802a correspond to the first convex portions 805a of the substrate 801a. The (third) concave portions 802a′ of the resist pattern 802a correspond to the fourth concave portions 805b. Next, the resist is removed by etching.

As shown in FIG. 22D, a magnetic film is deposited on the substrate 801a. Then, the magnetic film deposited on the first convex portions 805a of the substrate 801a serves as recording bits 803a. The magnetic film deposited on the fourth concave portions 805b of the substrate 801a serves as concave magnetic films 803a. In addition, materials suitable for a perpendicular magnetic recording are used for the magnetic film. Moreover, as the magnetic film, a double layer including a soft magnetic underlayer and a perpendicular magnetic recording layer are preferably employed. Next, the protective film 804 including carbon is provided on the magnetic film, and a lubricant agent is further given thereon. The magnetic recording medium according to the modified example of the first embodiment is thus completed using the above manufacturing process.

The magnetic recording medium was provided using the above manufacturing process. The medium was built into the magnetic recording apparatus 10. Read/write of magnetic signals to the data area of the medium resulted in good write-in and read-out of the signals.

Since the stamper according to the invention is used to imprint, a resist will be surrounded by 4 faces of the wall portions 101. However, the resist can outflow through the second concave portions 103 from one first concave portion to the adjacent first concave portions while imprinting in the manufacturing process of the magnetic recording medium using the stamper. That is, the second concave portion 103 connects the two adjacent first concave portions 102 in the circumferential direction, the resist being capable of flowing over two or more first concave portions. The resist capable of flowing over the two or more first concave portions 102 through the second concave portions 103 allows it to imprint uniformly, and to reduce imprinting pressures and nonuniformity of imprinted patterns. The second concave portions 103 assist in inflowing of the air between the stamper to be removed and the resist of the original disk when removing the stampers. This assist can suppress a portion of the resist adhering to the stamper, thus preventing the portion from being removed along with the stamper. This can also prevent the recording bits 32 supposed to be formed on the resist from being entirely removed. As a result, according to the stamper of the invention, the magnetic recording medium with few defects in the data region thereof can be acquired. When the magnetic recording medium is provided using the stamper according to the embodiment to be built into the magnetic recording apparatus, read/write of magnetic signals to the data area of the medium can results in good write-in and read-out of the signals.

The embodiments of the present invention have been described above. However, the present invention is not limited to the embodiments described above. For example, when those skilled in the art appropriately select to combine two or more of the examples as described above from a known range, and the same effect as described above can be obtained, they are also incorporated in the present invention.

The imprint stamper according to the first embodiment and the modified example is shown just as an example. Then the conditions and the order of the steps in the manufacturing process may be varied.

Although shapes and sizes of the pattern of the stamper have been shown specifically in the above described embodiment and the modified example, the shape and size of the pattern have been shown just as an example. Therefore, the shape and size may be selected to form the pattern and they are also incorporated in the present invention unless they deviate from the scope of the invention. For example, the second concave portions 103 were provided as a shape of the pattern in the first embodiment and the modified example. However, for example, holes and notches may be provided to the wall portion 101. In a word, paths to flow the resist should just be provided between one first concave portion 102 and the adjacent first concave portions 102. Moreover, although the imprint pattern was adopted so that one first concave portion was surrounded by 4 faces of the wall portions 101 in the embodiment, the pattern is not limited to this.

What is claimed is:

1. An imprint stamper for manufacturing a magnetic recording medium with a plurality of recording bits, comprising:
a plurality of first concave portions to form the recording bits;
a wall portion provided so as to separate the first concave portions from each other; and
a second concave portion provided to the wall portion so as to connect one of the first concave portions and the other of the first concave portions adjacent to one of the first concave portions.

2. The stamper according to claim 1,
wherein two or more of the second concave portions are provided to the wall portion surrounding one of the first concave portions; and
wherein one of the first concave portions is connected to two or more of the first concave portions adjacent to one of the first concave portions through two or more of the second concave portions.

3. The stamper according to claim 1, wherein a width of the second concave portions is 5 nm or more.

4. The stamper according to claim 1, wherein a depth of the second concave portions is 5 nm or more.

5. The stamper according to claim 1,
wherein a plurality of the second concave portions are arranged so as to result in a straight-line path; and
wherein the second concave portion connects a plurality of the first concave portions with each other.

6. The stamper according to claim 2, wherein a width of the second concave portions is 5 nm or more.

7. The stamper according to claim 2, wherein a depth of the second concave portions is 5 nm or more.

8. The stamper according to claim 2,
wherein a plurality of the second concave portions are arranged so as to result in a straight-line path; and
wherein the second concave portion connects a plurality of the first concave portions with each other.

9. The stamper according to claim 3, wherein a depth of the second concave portions is 5 nm or more.

10. The stamper according to claim 3,
wherein a plurality of the second concave portions are arranged so as to result in a straight-line path; and
wherein the second concave portion connects a plurality of the first concave portions with each other.

11. The stamper according to claim 4,
wherein a plurality of the second concave portions are arranged so as to result in a straight-line path; and
wherein the second concave portion connects a plurality of the first concave portions with each other.

12. A method for manufacturing a stamper, comprising the steps of:
forming a positive type photosensitive resin film on a substrate;
exposing an area of the positive type photosensitive resin film, so that a wall portion of the stamper is formed on the area;
developing the positive type photosensitive resin film to remove the area;
forming a conductive film on the positive type photosensitive resin film and the substrate after the developing;
forming an electroformed film on the conductive film; and
removing the conductive film and the electroformed film from the photosensitive resin film and the substrate.

13. A method for manufacturing a magnetic recording medium, comprising the steps of:
forming a resin layer on a substrate;
imprinting on the resin layer by using the stamper to provide a third concave portion on the resin layer, the third concave portions being arranged so as to correspond to a pattern of the wall portions of the stamper;
etching the resin layer with the third concave portion and the substrate to provide a fourth concave portion on the substrate, the fourth concave portions being arranged so as to correspond to a pattern of the wall portions of the stamper; and
forming a magnetic film on the substrate with the fourth concave portion to provide a plurality of convex recording bits, the recording bits being arranged so as to correspond to a pattern of the first concave portions of the stamper.
